(19) United States
(12) Patent Application Publication
(10) Pub. No.: US 2023/0324081 A1
(43) Pub. Date: Oct. 12, 2023

(54) AUTOMATIC HYDRAULIC MOTION SYSTEM OF ELEMENTS OF A COMPACT SOLAR COLLECTOR

(71) Applicant: Cordivari S.R.L., Morro d'Oro TE (IT)

(72) Inventors: Daniele Dl GIANNATALE, Morro d'Oro TE (IT); Ercole Cordivari, Morro d'Oro TE (IT)

(21) Appl. No.: 18/210,609

(22) Filed: Jun. 15, 2023

Related U.S. Application Data
(63) Continuation-in-part of application No. 18/205,509, filed on Jun. 3, 2023.
Application No. 18/205,509 is a continuation-in-part of application No. 16/316,620, filed on Jan. 9, 2019.

(30) Foreign Application Priority Data
Aug. 10, 2016 (IT) 102016000084083

(51) Int. Cl. F24S 50/80; F24S 50/40; F24S 30/42

(52) U.S. Cl. CPC F24S 50/80; F24S 50/40; F24S 30/42; F24S 2030/115

(57) ABSTRACT

The present invention relates to an automatic motion system by dilatation of a fluid, said system acting on elements of a compact solar collector with integrated storage tank, said solar collector having least a face exposed to the solar radiation and at least another face not facing the solar radiation, said solar collector comprising a plurality of primary tubes, for containing at least one primary heat carrier element adapted to the storage of thermal energy, and an external collector element arranged movable with respect to each primary conduit, adapted to overlap, at least partially, during its motion, in each primary conduit.

### CROSS-REFERENCE TO RELATED APPLICATIONS

The present application is a continuation-in-part of U.S. application Ser. No. 18/205,509 filed on Jun. 3, 2023, which is the continuation-in-part of U.S. application Ser. No. 16/316,620 filed on Jan. 9, 2019, which is the National Stage of International Application No. PCT/IT2017/000166 filed on Aug. 4, 2017, which claims the priority benefit of Italian Application No. 102016000084083 filed on Aug. 10, 2016, the disclosures of which are hereby incorporated by specific reference thereto.

### BACKGROUND OF THE INVENTION

The present invention relates to an automatic motion system of elements of a compact solar collector with an integrated storage tank.

More specifically, the present invention relates to a motion system for actuating kinematics in solar systems automatically operated by increasing of the temperature of a fluid within a set technical volume.

As it is known, a fluid subjected to a temperature increase naturally increases its volume. In the event it is not possible to provide the fluid during the dilation stage in the volume required for its expansion, it will tend to increase its pressure as long as the temperature increase does not cease. The pressure generated within the aforementioned technical volume can be exploited to operate devices by converting the energy contained in the fluid, in this case in the form of pressure, into other forms.

This principle is used in some devices such as thermostatic devices, for automatically regulating heaters, and thermostatic lever valves used to regulate air dragging in biomass heaters.

The thermostatic devices are essentially of three types: wax, liquid, and gas heaters. In the wax ones, a collector is made of a hard casing filled with wax. When the temperature increases, wax dilates and pushes a shutter into a closure position by overcoming the resistance of a preloaded spring. These wax devices are collectors characterized by long response times (many tens of minutes) to reach a balancing position.

In liquid thermostatic devices, the collector comprises a rigid casing filled with a liquid, usually alcohol, acetone or organic liquid mixtures similar to those used in thermometers. As the temperature increases, the liquid expands and pushes the shutter into a closure position, again by overcoming the resistance of a preloaded spring. They are currently among the most used collectors because they can ensure a good response time.

In the gas type of thermostatic device, the collector comprises a rigid casing filled with a gas. As the temperature increases, the gas dilates and pushes the shutter into a closure position against the resistance of the preloaded spring. Gas is compressible, and this can be a problem in the presence of too high differential pressures that can lead to unwanted opening of the shutter.

Valves used in biomass stoves use the same principle as thermostatic devices. When the temperature of water in the interspace of a generator is varied, a dragging adjuster modifies the opening of a combustion air intake door by dilatation or contraction of a thermostatic collector connected to a lever mechanism formed by a control shaft and chain.

It is also known that compact solar collectors generally have a large dimension and a reduced thickness, and contain inside them the storage tank of the fluid to be heated, preferably sanitary water. Such systems have excellent energy exchange efficiency and low thermal inertia efficiency. In case of compact indirect irradiation solar collectors, they also include a storage tank for a direct solar irradiated primary fluid, and can provide heat to the primary fluid to be heated and/or a secondary fluid.

Compact solar collectors also have the advantage of being simple to install, as it is sufficient to connect the inlet and outlet tubes.

At present, such compact solar collectors have the disadvantage of not maintaining the same thermal efficiency during night time. In fact, since the accumulation of fluid to be heated is directly exposed to sunlight, it tends to reduce during night time. Thus, the day-catching efficacy generates the same limit as the capability to maintain the accumulated energy overnight. At present, no solutions exist that are able to insulate such accumulation without inhibiting the necessary collecting capacity.

Alternatively, known techniques include solar collectors comprising a collector capable of collecting solar energy, and a separate storage tank to store the fluid to be heated, with a fluid connection to the collector device. The accumulation is therefore appropriately insulated from the outside, and allows storage of accumulated heat during daytime hours, and limiting dispersions to the outside. However, in such solar collectors, the accumulation has far larger dimensions than its net useful capacity to contain the heated liquid.

Further, compact solar collectors including vacuum tubes are known as collector elements, within which are arranged the tubes in which the fluid flows that is to be heated. Vacuum tubes reduce night thermal dispersions through the upper cover. As it is well known, the best thermal insulator is vacuum because no convective thermal exchange mechanisms occur, due to the free circulation of vortices that are generated within all fluids due to the temperature gradients. In these collectors, the collector system is positioned within special concentric tubes to which the task of thermal isolation of the collector is due. This insulating capacity is achieved by a chamber in which the vacuum is created. Thanks to the insulating characteristic of the vacuum tubes, it is therefore possible to increase the temperature of the fluid to be heated flowing through the tubes. However, the temperature of such fluid can sometimes reach very high levels. If overheating becomes uncontrolled, damage to the implant or its components may occur.

A problem directly due to excessive overheating of the tubes is connected to excessive limestone precipitation. In fact, with excessive heating, water with a high hardness value (containing high amounts of limestone) causes excessive precipitation of limestone that can lead to the encrustation of tubes or ducts.

At present, there are also systems of solar shields electrically operated and controlled by a temperature collector placed inside the solar collector or the system. Such systems are essentially comprised of an electric motor and a shielding system. In the flat collectors field, shielding is generally made up of a shutter, while in the vacuum tube collectors, it can be either a shutter or lamellae coaxial with respect to the collector tubes. The weakness of these types of shields lies in the fact that, in the absence of electric current, they are not able to guarantee the protection of the solar system against overtemperature or, when placed in a closed condition in case of power failure, the interruption of the system itself.

Another necessary condition is the need to receive power through suitable systems in the installation locations.

Another generic limitation of such electrical shielding systems is that they are usually not modulating because they interact with the logic on/off collector system on the temperature readings established on a timely basis.

### SUMMARY OF THE INVENTION

An object of the present invention is to replace the normal electric drives with systems capable of ensuring the protection of solar collectors in any condition, even in the absence of electric current, and with the intrinsic ability to self-regulate the solar system collector when needed.

It is also an object of the present invention to provide an automatic motion system by dilatation of a fluid which acts on elements of a compact solar collector with an integrated storage tank. This novel solar collector has at least a face exposed to the solar radiation and at least another face not facing the solar radiation, and comprises a plurality of primary tubes for containing at least one primary heat carrier element adapted to store thermal energy, and an external collector element arranged to be movable with respect to each primary conduit and adapted to overlap, at least partially, during its motion, in each primary conduit.

An embodiment of the system according to the present invention provides a return spring acting on a hydraulic cylinder.

Further, according to the present invention, each collector element is able to rotate on itself, preferably by at least 180°, with respect to a respective primary duct.

According to the present invention, drive and transmission means preferably comprise at least a hydraulic cylinder and motion transmission mechanisms such as one or more racks.

In such embodiment, transmission of motion is realised by gears having different dimensions.

Also, according to an embodiment of the present invention, the rack acts simultaneously on all the gears.

Furthermore, the collector element is comprised of a vacuum tube, disposed coaxially with respect to each primary tube.

Moreover, the shielding element is comprised of the same collector tube, in particular by a portion of the tube which is suitably made opaque to solar radiation.

According to the present invention, drive and transmission means acting on external collector elements are configured so as to move the external collector elements between a sensing position and a shielding position, and vice versa, as a function of the pressure in the primary tubes and/or as a function of at least one primary heat carrier element temperature.

Still further according to the present invention, the drive and transmission means are configured so that, when the pressure increases in said primary tubes above a first value, the drive and actuating means act on the external collector elements to move them towards a shielding position, and when pressure decreases in the primary tubes, actuating means move the external collector elements towards the sensing position.

In the case of a temperature increase, fluid that is allowed to expand can be exploited to operate kinematics in solar collectors. In particular, these kinematics operate shields to prevent the panel from stagnating. Even more particularly, these kinematics move vacuum tubes of compact or standard panels, lamellae coaxial with respect to compact or standard panel vacuum tubes, and shutters in flat panels.

By the novel present system, it is also possible to move the solar collector, either flat or tubular, so as to favorably align the collecting surface with respect to the sun's rays and thereby increase the effective efficiency of the system.

The motion of the entire collector can also be exploited to prevent the system from continuing to absorb solar radiation in case of a rise in temperature beyond a threshold value.

By dimensioning the hydraulic cylinder on the basis on the force required to operate the kinematics and the volume required for the expansion of the technical accumulation, it is possible to obtain mechanisms with multiple characteristics in terms of force and driving.

The choice of the stroke and characteristics of the hydraulic cylinder is carried out in such a way so as to ensure the full expansion volume of the primary fluid is obtained by the operating temperature range. This also limits a pressure increase which, given the use of incompressible fluid, would tend to be high. That is, the system also functions as an expansion vessel.

Since there is a single pressure in this automatic hydraulic system, the return of the hydraulic cylinder will preferably be carried out by means of a suitably dimensioned return spring. The use of the spring allows accumulation of a sufficient amount of energy in the form of elastic energy that will be returned at the return stroke or when the cylinder operation pressure tends to decrease.

### BRIEF DESCRIPTION OF THE DRAWINGS

The present invention will now be described for illustration, but not for the purpose of limitation, with particular reference to the figures of the accompanying drawings, in which:

FIG. 1 is a perspective view of an embodiment of the motion system according to the present invention;

FIG. 2 is a side view of the system of FIG. 1;

FIG. 3 is a perspective view of another embodiment of the motion system according to the invention;

FIG. 4 is a side view of the system of FIG. 3;

FIG. 5 is a perspective view of yet another embodiment of the motion system according to the invention;

FIG. 6 is a side view of the system of FIG. 5;

FIG. 7 is a perspective view of a further embodiment of the motion system according to the invention;

FIG. 8 is a side view of the system of FIG. 7; and

FIGS. 9 and 10 are exploded views of the system of FIG. 7.

### DETAILED DESCRIPTION OF THE INVENTION

In a solar collector, the shielding system has the function of blocking solar radiation and not allowing its penetration inside the collector to the tube portion with selective coating, and thus, contributes to the heating of the primary fluid.

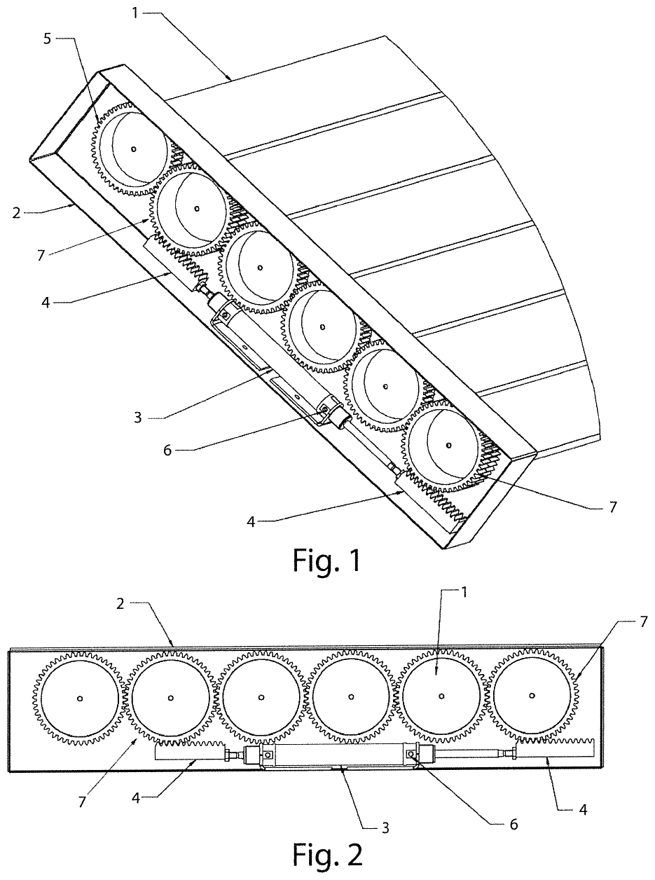

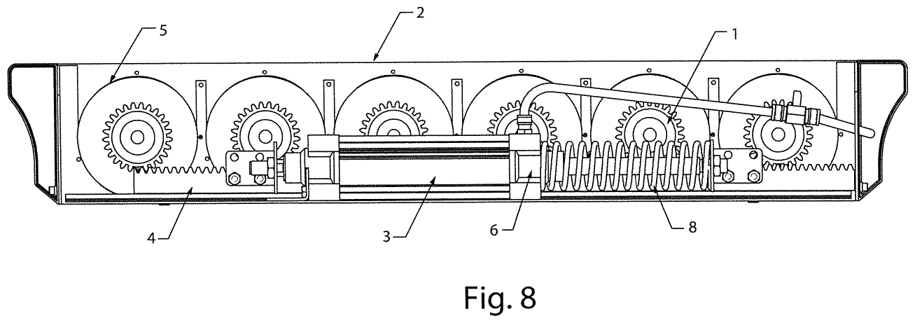

In FIGS. 1 to 10, the system according to the present invention is shown applied to a solar collector, in which the shielding system is formed by the same glass tubes that also act as collectors.

However, the same system can also be provided on solar collectors provided with a different protection system, such as rotating laminae, which cover a single tube 1 for a 180° arc.

In the embodiment shown in the figures, for example, films are applied on each collector tube, such films being opaque to the solar radiation initially directed on the opposite side to the sun's rays. When the system temperature rises, the pressure inside the primary fluid begins to increase. At such point, the automatic shielding system engages. By means of rack and toothed wheels, the linear motion of the piston is converted into a rotary motion, allowing the collector tubes to expose the shielding part. At this point, the solar collector begins to self-regulate. A set pressure increase will correspond to the advancement of the piston and its exposure by the collectors of the opaque surface. When the pressure decreases due to a decrease in the solar collector temperature, for example due to a user's energy withdrawal or to a decrease in solar irradiation, the piston will correspondingly retract so as to bring the system into collector mode, i.e., with the shielding part in the starting position.

Referring particularly to FIGS. 1 and 2, a first embodiment of the system according to the invention includes the glass collector tube 1, the structure 2, the hydraulic cylinder 3, the rack 4, the driven toothed wheels 5, the hydraulic cylinder pressure intake 6, the drive gear wheels 7, and the integrated storage tank 10. The hydraulic cylinder may include a hydraulic cylinder pressure intake connected to the cylinder, and a fluid pressure line attached to the intake through which the fluid pressure within said primary conduits is transmitted.

In this specific embodiment, the hydraulic cylinder 3 acts on two driving wheels 7, which, with the adjacent gears, transfer the rotary motion to the whole conduit system 1. The driving wheels 7 have a greater gear width so as to allow the rack 4 to engage without interfering with the teeth of the wheels 5.

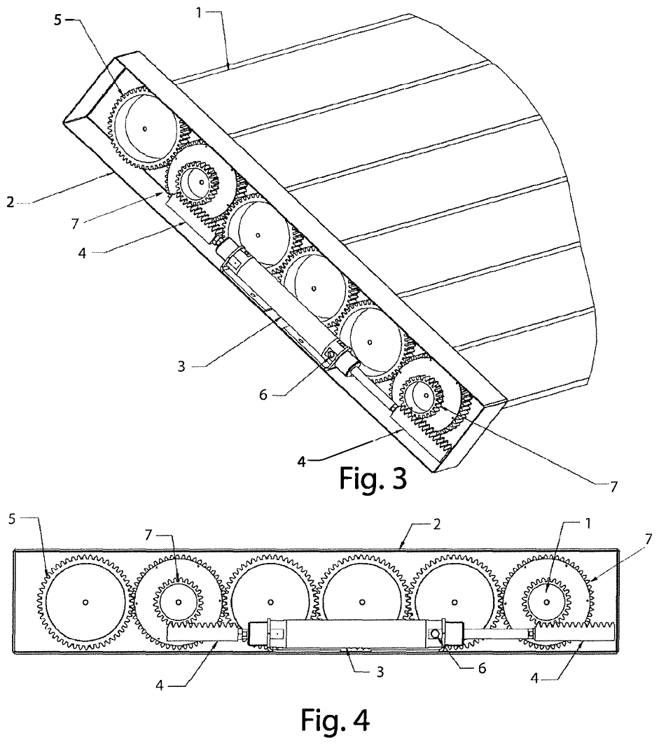

In the embodiment shown in FIGS. 3 and 4, respectively, the driving wheels 7 have a lower diameter than that of the previous embodiment. In this way, with the same stroke of the hydraulic cylinder 3, it is possible to make the tube system 1 realizing a larger rotation.

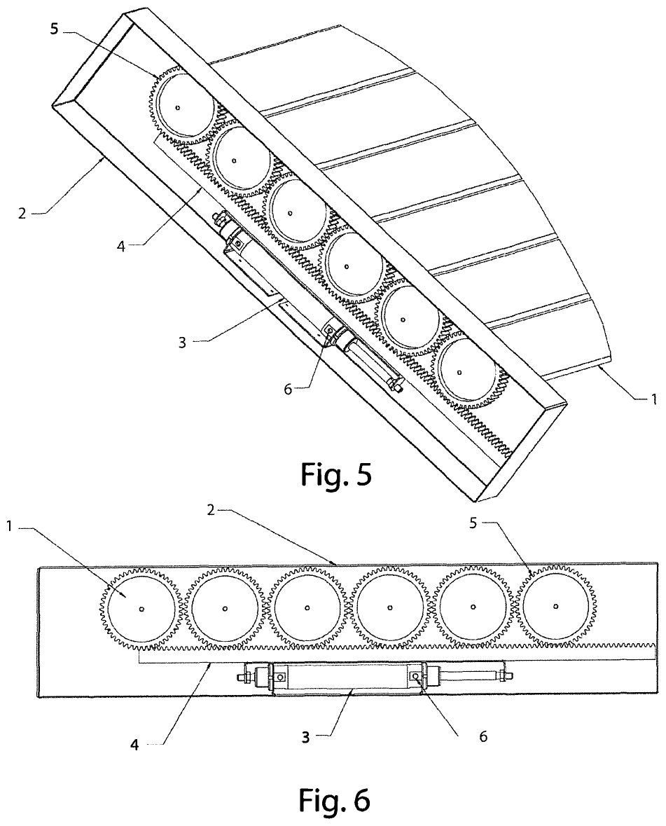

In the embodiment of FIGS. 5 and 6, the rack 4 acts on all the toothed wheels 5 simultaneously. Wheels 5 do not engage each other, allowing the system according to the invention to be operated using a lesser force for its motion, since the friction component introduced by mutual interaction between the wheels has been eliminated.

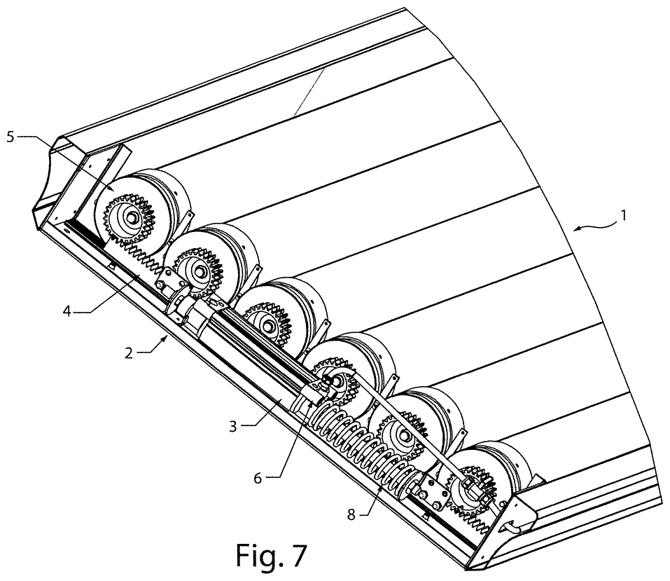

In the embodiment in FIGS. 7-10, besides eliminating the friction component due to mutual interaction between the teeth of the wheels 5 by using smaller diameter driving wheels, it is possible to obtain the desired rotation of the tube system 1 using a lower stroke for cylinder 3. Therefore, a shorter length of the rack 4 and, consequently, a greater compactness of the whole system according to the present invention, may be provided.

On the piston rod, there is provided a return spring 8. This embodiment, for its adjustment, requires the optimization of various variables, such as the features of the return spring 8, fluid volume which, by expanding, activates the cylinder 3, characteristics of hydraulic cylinder 3, nature and dimensions of the transmission of the motion means 4, 5, 6, 7, etc.

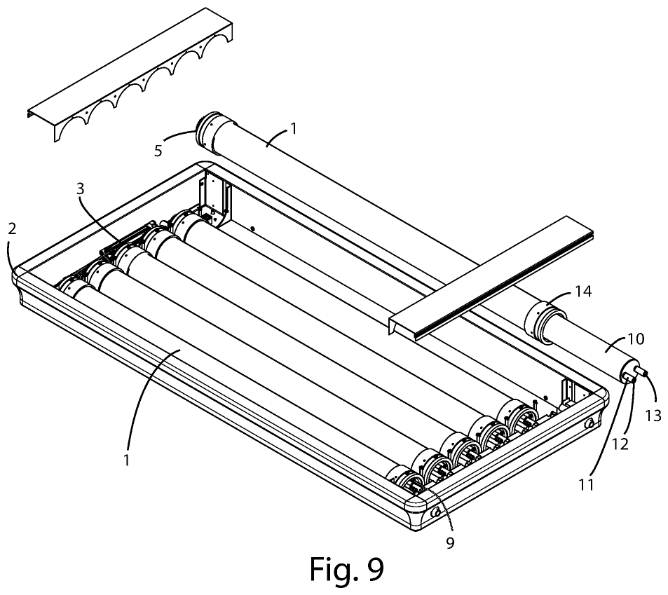

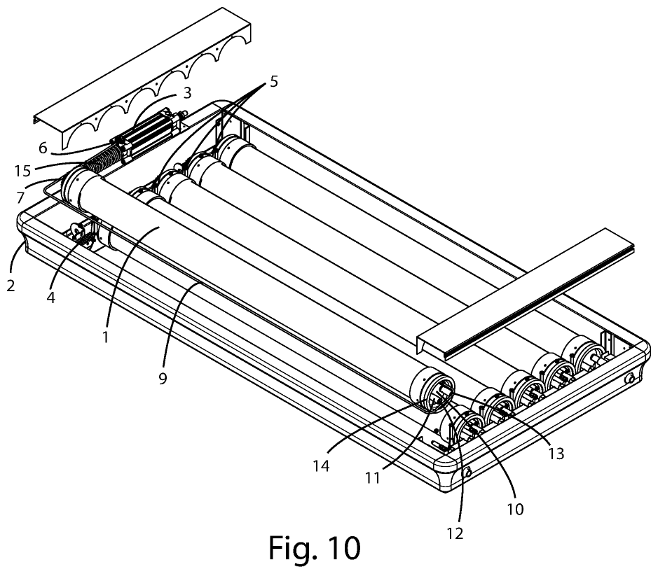

Referring particularly to FIGS. 9 and 10, it can be observed that the integrated storage tank comprises a plurality of inner storage tubes 10 for storing the primary fluid. Each inner storage tube 10 is inserted within the respective collector tube 1 and coupled to it by means of a coupling support 14. Within each inner storage tube 10 it is provided a secondary fluid conduit 11 for the flow of a secondary fluid within the inner primary fluid storage tube and comprising an inlet 12 and an outlet 13 connection.

The hydraulic cylinder 3 may include a hydraulic cylinder pressure intake 6 connected to the cylinder 3, and a fluid pressure line 9 attached to the intake 6 through which the fluid pressure within said primary conduits 1 is transmitted. The function of the fluid pressure line 9 is to transfer the pressure increase generated by the rise in temperature from a collector tube 1 (called the motor tube) to the hydraulic cylinder 3. The fluid pressure line 9 is inserted into the pressure intake 6 that faces directly into the cylinder 3 chamber that drives the piston rod 15. In this way, cylinder 3 and motor tube 1 are placed in direct fluid communication. Advancement of the cylinder 3, which drags the whole mechanism with it, occurs if the temperature, and consequently the corresponding pressure, is sufficiently high. When the motor tube 1 cools and the pressure consequently tends to decrease, the spring 8 brings the cylinder 3 back.

In particular, the characteristics of the spring 8 in terms of length, useful stroke and elastic constant, must allow for the counter-force required to make the movement reversible. The spring 8 will then be dimensioned to ensure, with a preload choice, the required force.

The characteristics of the hydraulic cylinder 3 allow it to deliver the required force for movement and, at the same time, ensure the fluid expansion volume so as not to reach pressures that are too high.

The geometry of the motion transmitting means 4, 5, 6, 7 also is configured to allow the optimization of shielding degree. Particularly, the specific choice of this geometry allows for the rotation of the required shield with the minimum stroke of the piston by reducing the cost, weight, and size of the hydraulic cylinder.

The balance created between these different features allows for a dynamic shielding of the solar collector.

Particularly, when the temperature within the primary fluid grows, the system begins to move and partially block incoming solar radiation as long as the power provided by the sun is exactly the same as that dissipated from the system in terms of thermal dispersions.

In this invention, maximum efficiency of the system is always ensured and at the same time, the integrity of the system is maintained as the high temperatures are limited.

Further, the use of adhesive shielding elements helps to avoid problems that can be caused by the wind. Additionally, positioning shields independently rotating with respect to the glass tubes may lead to instability or resonance phenomena that would put the tube's integrity at risk.

Preferred embodiments have been described, and variants of the present invention have been suggested, but it is to be understood that those skilled in the art will be able to make modifications and changes without departing from the scope as defined by the enclosed claims.

1. An automatic motion system by dilation of a primary heat carrier fluid for acting on elements of a compact solar collector with an integrated storage tank for a fluid to be heated:
said compact solar collector with the integrated storage tank comprising a plurality of primary conduits for containing the primary heat carrier fluid adapted to the storage of thermal energy, and an external collector element arranged movably with respect to each primary conduit;
each external collector element is a vacuum tube within which is arranged a respective primary conduit in which the fluid to be heated flows, and each external collector element is configured to rotate on itself, with respect to the respective primary conduit and to at least partially overlap each primary conduit during its motion;
each external collector element has at least a first collecting face configured to collect solar radiation, and at least a second shielding face suitably made opaque to solar radiation;
the automatic motion system includes automatic drive and transmission mechanisms comprising at least one hydraulic cylinder with a piston on which is at least one return spring configured to act on the piston, a hydraulic cylinder pressure intake, at least one toothed rack, and toothed gears carried by the external collector elements, whereby said automatic drive and transmission mechanisms are configured to move said external collector elements from the first face of a collecting position automatically as a function of a pressure of the primary heat carrier fluid increasing beyond a set technical volume to actuate, via the primary heat carrier fluid pressure to the intake, the piston in the hydraulic cylinder to move the rack to engage the gears to the second face of a shielding position, and the spring acts on the piston to move the rack to engage the gears to return the external collector elements to the first face of the collecting position as a function of the pressure of the primary heat carrier fluid decreasing below a set technical volume,
whereby the compact solar collector is automatically protected from damage by excessive solar radiation using dynamic shielding, and the motion system automatically operates by an intrinsic ability to self-regulate with no external control and no external power source other than solar energy.

2. The system according to claim 1, wherein transmission of motion is realized by gears having different dimensions.

3. The system according to claim 2, wherein the gears comprise driven toothed wheels and drive gear wheels, and the rack acts on said drive gear wheels but not on said driven toothed wheels.

4. The system according to claim 1, wherein the rack acts simultaneously on all the gears.

5. The system according to claim 4 wherein the gears do not engage each other.

6. The system according to claim 1, wherein said shielding portion of each external collector element is suitably made opaque to solar radiation by opaque adhesives or films.

7. The system according to claim 1, wherein said drive and transmission mechanisms are configured to move said external collector elements between a collecting position and a shielding position, and vice versa, as a function of at least one primary heat carrier element temperature.

8. The system according to claim 1, wherein each collector element is configured to rotate on itself, 180° with respect to the respective primary conduit.

9. The system according to claim 7, wherein transmission of motion is realized by gears having different dimensions.

10. The system according to claim 9, wherein the gears comprise driven toothed wheels and drive gear wheels, and the rack acts on said drive gear wheels but not on said driven toothed wheels.

11. The system according to claim 7, wherein the rack acts simultaneously on all the gears.

12. The system according to claim 11, wherein the gears do not engage each other.

13. The system according to claim 7, where said shielding position of each external collector element is suitably made opaque to solar radiation by opaque adhesives or films.

14. The system according to claim 7, wherein each collector element is configured to rotate on itself, 180° with respect to the respective primary conduit.

15. The system according to claim 1, wherein geometry of the drive and transmission mechanisms is configured to allow rotation of the required collectors by at least one driving wheel having an undersized diameter, and rotation of the collectors is obtained with a short rack and minimum stroke of the piston, thereby reducing the weight and size required for the hydraulic cylinder and for the spring to act on the hydraulic cylinder.

16. The system according to claim 7, wherein geometry of the drive and transmission mechanisms is configured to obtain rotation of the required collectors by at least one driving wheel having an undersized diameter, and rotation of the collectors is obtained with a short rack and minimum stroke of the piston, thereby reducing the weight and size required for the hydraulic cylinder and for the spring to act on the hydraulic cylinder.

17. The system according to claim 1, wherein the hydraulic cylinder pressure intake is connected to the cylinder, and includes a fluid pressure line attached to the intake through which the fluid pressure within said primary conduits is transmitted.
